(19) United States
(12) Patent Application Publication
(10) Pub. No.: US 2007/0250737 A1
(43) Pub. Date: Oct. 25, 2007

(54) Method and Apparatus for Aligned Data Storage Addresses in a Raid System

(75) Inventors: Ambalavanar Arulambalam, Macungie, PA (US); Richard J. Byrne, Hillsborough, NJ (US); Jeffrey L. Timbs, Orefield, PA (US); Nevin C. Heintze, Bethlehem, PA (US); Silvester Tjandra, Singapore (SG); Eu Gene Goh, Singapore (SG); Nigamanth Lakshminarayana, Allentown, PA (US)

Correspondence Address: DUANE MORRIS LLP;IP DEPARTMENT (AGERE), 30 SOUTH 17TH STREET, PHILADELPHIA, PA, 19103-4196, US

(73) Assignee: Agere Systems Inc., Allentown, PA (US)

(21) Appl. No.: 11/539,339

(22) Filed: Oct. 6, 2006

Related U.S. Application Data
(63) Continuation-in-part of application No. 11/226,507, filed on Sep. 13, 2005.
(63) Continuation-in-part of application No. 11/273,750, filed on Nov. 15, 2005.
(63) Continuation-in-part of application No. 11/364,979, filed on Feb. 28, 2006.
(63) Continuation-in-part of application No. 11/384,975, filed on Mar. 20, 2006.
(60) Provisional application No. 60/724,692, filed on Oct. 7, 2005.
(60) Provisional application No. 60/724,464, filed on Oct. 7, 2005.
(60) Provisional application No. 60/724,462, filed on Oct. 7, 2005.
(60) Provisional application No. 60/724,463, filed on Oct. 7, 2005.
(60) Provisional application No. 60/724,722, filed on Oct. 7, 2005.
(60) Provisional application No. 60/725,060, filed on Oct. 7, 2005.
(60) Provisional application No. 60/724,573, filed on Oct. 7, 2005.

(51) Int. Cl. G06F 11/08

(52) U.S. Cl. 714/6

(57) ABSTRACT

A method includes providing a redundant array of inexpensive disks (RAID) array having at least a stripe sector unit (SSU) of data written to it. A request is received to perform a write operation to the RAID array beginning at a starting data storage address (DSA) that is not aligned with an SSU boundary. An alert is generated in response to the request.

This application is a continuation in part of U.S. patent application Ser. No. 11/226,507, filed Sep. 13, 2005, and is a continuation in part of U.S. patent application Ser. No. 11/273,750, filed Nov. 15, 2005, and is a continuation in part of U.S. patent application Ser. No. 11/364,979, filed Feb. 28, 2006, and is a continuation in Part of U.S. patent application Ser. No. 11/384,975, filed Mar. 20, 2006, and claims the benefit of U.S. provisional patent application Nos. 60/724,692, filed Oct. 7, 2005, 60/724,464, filed Oct. 7, 2005, 60/724,462, filed Oct. 7, 2005, 60/724,463, filed Oct. 7, 2005, 60/724,722, filed Oct. 7, 2005, 60/725,060, filed Oct. 7, 2005, and 60/724,573, filed Oct. 7, 2005, all of which applications are expressly incorporated by reference herein in their entireties.

### FIELD OF THE INVENTION

The present invention relates to storage systems incorporating Redundant Array of Inexpensive Disks (RAID) technology.

### BACKGROUND

To provide streaming writes to RAID arrays, conventional RAID systems use a Read Modify Write sequence to write data to the RAID Array.

FIG. 5 shows a conventional RAID array, using a parity placement that distributes parity bits in a round robin manner across the drives of a disk array cluster. Parity chunks are rotated through the data chunks of stripes. FIG. 5 shows an array where there are five disks (N=5). The data chunks are represented by lower case characters while the uppercase P character represents Parity chunks.

To send data to a hard disk drive (HDD) and record parity information, the data are divided into sectors. Typically a RAID system records several sectors on one disk and several sectors on a second HDD and several sectors on a third HDD and then records the parity bits. To modify some of the stored data, the RAID system needs to first read all of that data, and then make the changes, and then write the data back to disk. This sequence is referred to as Read-Modify-Write (RMW).

The Read-Modify-Write operation handles bursts that are not aligned with striped sector units. Misaligned bursts can have partial data words at the front and back end of the burst. To calculate the correct Parity Sector value, a Read-Modify-Write Module forms the correct starting and ending data words by reading the existing data words and combining them appropriately with the new partial data words.

However, the Read Modify Write sequence blocks the write until the striped sector unit can be read and parity modified.

### SUMMARY OF THE INVENTION

In some embodiments, a method comprises providing a redundant array of inexpensive disks (RAID) array having at least a stripe sector unit (SSU) of data written thereto. A request is received to perform a write operation to the RAID array beginning at a starting data storage address (DSA) that is not aligned with an SSU boundary. An alert is generated in response to the request.

In some embodiments, a method includes providing a redundant array of inexpensive disks (RAID) array having at least a stripe sector unit (SSU) of data written to it. The SSU of data beings at a first SSU boundary. A request is received from a requestor to write an amount of additional data to the RAID array. The additional data are padded, if the amount of the additional data is less than an SSU of data, so as to include a full SSU of data in the padded additional data. The full SSU of data is stored beginning at a starting data storage address (DSA) that is aligned with a second SSU boundary, without performing a read-modify-write operation. Some embodiments include a system for performing the method. Some embodiments include a computer readable medium containing pseudocode for generating hardware to perform the method.

### BRIEF DESCRIPTION OF THE DRAWINGS

FIG. 1 is a block diagram of an exemplary RAID decoder/encoder (RDE) module.

FIG. 2 is a block diagram of the write operation scheduler (WOS) of FIG. 1

FIG. 3 is a state diagram for a write operation.

FIG. 4 is a diagram showing mapping of stripe sector units to physical drives in an embodiment of the invention.

FIG. 5 is a diagram showing mapping of stripe sector units to physical drives in a conventional system.

FIG. 6 is a flow chart of an exemplary method that is performed by the RDE module of FIG. 1.

### DETAILED DESCRIPTION

This description of the exemplary embodiments is intended to be read in connection with the accompanying drawings, which are to be considered part of the entire written description.

Terminology

SATA is an acronym for Serial AT Attachment, and refers to the HDD interface.

FIS is the SATA acronym for its Frame Information Structure

RAID levels
RAID-x is an acronym that stands for “Redundant Array of Inexpensive Disks at level x”
RAID level 0 specifies a block-interleaved disk array.
RAID level 1 specifies a disk array with mirroring.
RAID level 4 specifies a block-interleaved dedicated parity disk array.
RAID level 5 specifies a block-interleaved distributed parity disk array.
RAID level 1, 4 and 5 arrays support redundancy, meaning that if any one drive fails, the data for the failed drive can be reconstructed from the remaining drives. If such a RAID array is operating with a single drive identified as failed, it is said to be operating in a degraded mode.

Sectors

A sector, the basic unit of reads and writes, is a uniquely addressable set of predetermined size, usually 512 bytes. Sectors correspond to small arcs of tracks on disk drive platters that move past the read/write heads as the disk rotates.

A Data Sector Unit (DSU) is a sector's worth of data.

A parity Sector Unit (PSU) is a sector's worth of parity as derived from the bit-wise exclusive-OR of the data in the N−1 data sector Units of an SSU.

Logical Block Address (LBA) sector addressing

A logical Block Address (LBA) is a means of referring to sectors on a disk drive with a numerical address rather than the alternate sector of head on a cylinder method. With a LBA, the sectors are numbered sequentially from zero to S−1 where S is the number of sectors on a disk. In some embodiments, the LBA is forty eight bits long. Other LBA lengths may be used, for example, to accommodate disks of different capacity.

Stripe Sector Unit (SSU)

A Stripe Sector Unit (SSU) is a set of sectors, collected one from each disk array drive. The set of sectors in an SSU share the same LBA, thus a specific SSU is referenced by the common LBA of its member sectors. For a block-interleaved distributed parity disk array with N number of drives, an SSU holds N−1 data sectors and one sector of parity.

Chunks

An array's chunk-size defines the smallest amount of data per write operation that should be written to each individual disk. Chunk-sizes are expressed as integer multiples of sectors. A Chunk is the contents of those sectors.

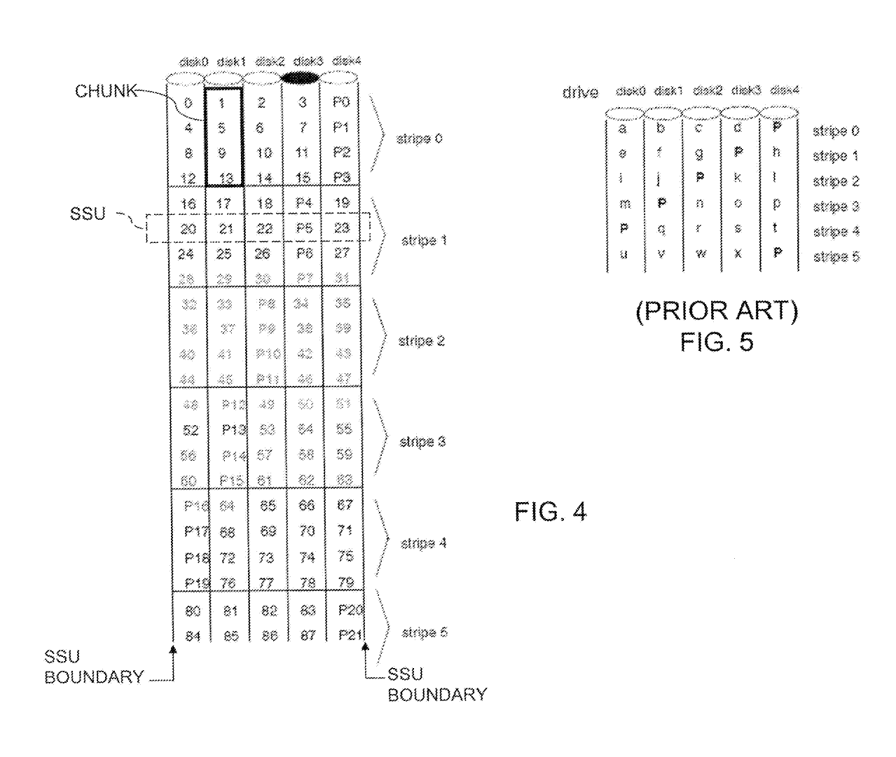

In FIG. 4, the set of sectors numbered [1,5,9,13] comprise a chunk of data on disk 1, whereas sector set labeled [P0,P1,P2,P3] comprise a chunk of Parity on disk 4. A chunk may contain either parity or data.

Stripes

A Stripe is a set of Chunks collected one from each disk array drive. In some embodiments, parity rotation through data is by stripes rather than by SSUs.

Data Sector Address (DSA)

A data Sector Address (DSA) is a means of referring to data sector units on a disk array with a numerical address. As illustrated in FIG. 4, the data sectors are numbered sequentially from zero to D−1 where D is the total number of Data Sector Units in the RAID array cluster. Parity Sector Units are not included in a DSA. In other words, the sequential numbering is not advanced for Parity Sector Units. The exemplary DSA scheme advances across an SSU. It does not cover stripes by first advancing through a chunk's worth of sectors on any one drive.

In some embodiments of the invention, sectors are always aligned on DSA boundaries, and write operations always being on SSU boundaries. As a result, the Read-Modify-Write (RMW) step can be eliminated.

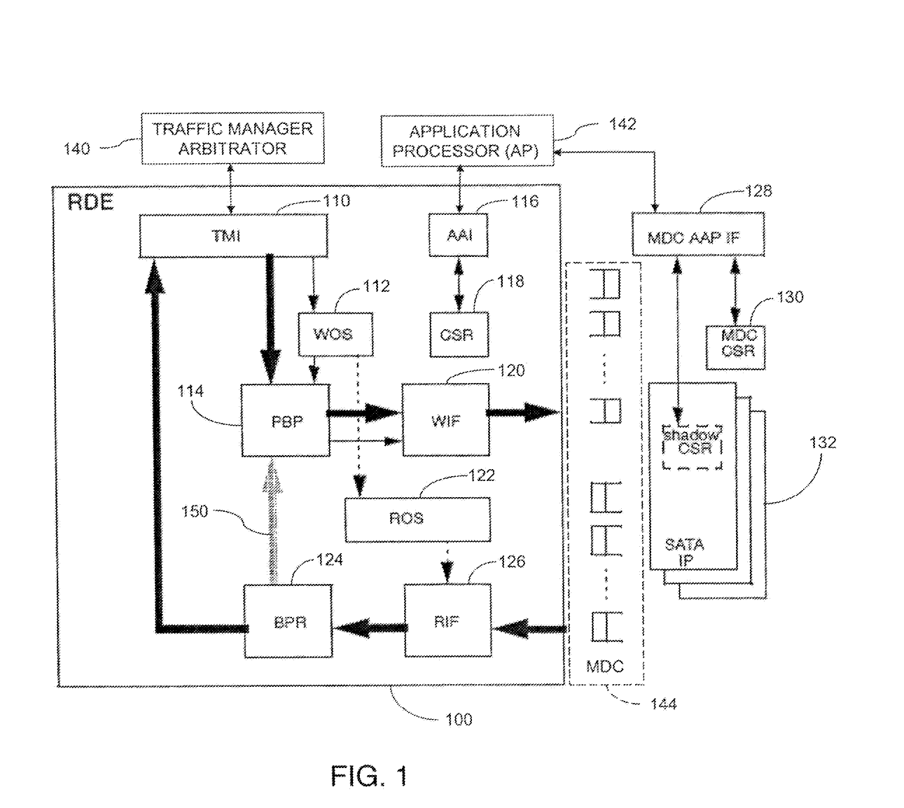

FIG. 1 is a block diagram of an exemplary RAID decoder/encoder (RDE) block 100 in which embodiments of the method and apparatus may be used. RDE block 100 provides an interface between an HDD (or HDD array) 132 and a system application processor (AP) 142.

The AP Interface (AAI) 116 provides access to a memory mapped application processor (AP) 142 and its accessible registers and memories (not shown). AP 142 may be, for example, an embedded ARM926EJ-S core by ARM Holdings, plc, Cambridge, UK, or other embedded microprocessor. The Block Parity Reconstruction (BPR) module 124 passes retrieved data to the traffic manager interface (TMI) 110, which is connected to a traffic manager arbiter (TMA) 140. TMA 140 receives incoming data streams from external (i.e., external to the RDE block 100) systems and/or feeds, and handles playback transmission to external display and output devices. BPR 124 reconstructs the data when operating in degraded mode. The BPR operation is directed by the read operation sequencer (ROS) sub-block 122. The parity block processor (PBP) 114 performs Block Parity Generation on SSU sector data as directed by the write operation sequencer (WOS) sub-clock 112. MDC control and status registers (CSR) 130 are connected to an MDC AP interface 128, to provide direct register access by AP 142.

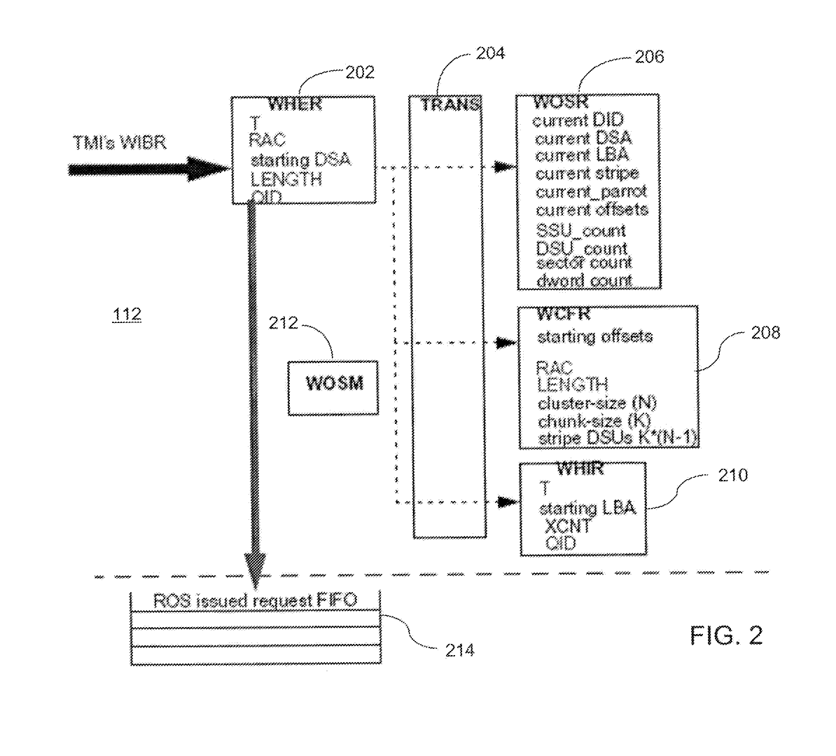

The read interface (RIF) 126 retrieves responses to issued requests described in an issued-requests-FIFO 214 (shown in FIG. 2). The RIF 126 performs Logical Drive Identification to Physical Drive Identification RAID array cluster (RAC) mapping as requested by the ROS 122. Drive Identification (DID) is presented on a bus (not shown) to which the RDE 100 and MDC 144 are connected. ROS 122 looks for and checks responses to issued requests defined in the issued requests FIFO 214. The Write interface (WIF) 120 buffers requests for storage and retrieval operations, and communicates them to the multi-drive controller (MDC) block 144, to which the disks 132 are connected. Write Operations are executed as commanded by the WOS sub-block 112. As these requests are written to the pending write FIFO, and then sent to the MDC, information is also written by the WOS 112 to the issued request FIFO of the ROS sub-block 122. The Register Map describes the registers in the RDE Register File.

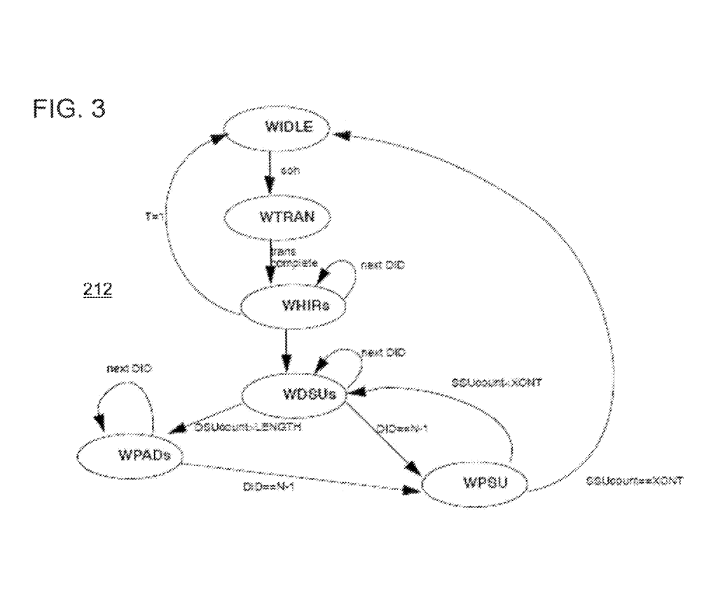

Storage request frames and Retrieval request frames are drawn into the Write Input Buffer Registers as demanded by the Write Operation State Machine (WOSM) (discussed below with reference to FIGS. 2 and 3).

In the RDE block 100 of FIG. 1, data come in from traffic manager (TMA) 140 via TMI 110, pass through the PBP 114, pass through a write interface 120, and is delivered to MDC 144. According to an exemplary embodiment, when an entire SSU is written in alignment with the DSA boundary, the signal indicated by the gray arrow 150 (between BPR 124 and PBP 114) is not needed. In embodiments in which SSUs are aligned to DSA boundaries, the data for the entire SSU are written, and a new ECC for the entire SSU can be generated without retrieving any prefix or suffix data from HDD 132. Thus, it is not necessary to stall the pipeline, or to wait for a retrieval of data, data update in a buffer and parity data write operation. Instead, in a RAID system with several disk drivers 132 (e.g., SATA type HDD's, PATA type HDD's or the like), coupled to MDC 144, an SSU of data can be modified without first reading out all the data. With the SSUs aligned to the DSA boundary, RDE 100 writes out an entire SSU of data. Because the entire SSU of data is written to disk, the system can calculate the correct ECC value without first reading data from disk, and an RMW operation is not needed.

FIG. 4 shows an example of DSA Data Sector Addressing. In the context of FIG. 4, an SSU would be one of these rows. When a write is performed, a full SSU (row) is written out. Therefore, an RMW is not required to write that SSU out. The operating system ensures that the write operation is not delayed while data are read out, because no prefix or suffix data are needed.

In the exemplary embodiment, for storage, TMA 140 only provides DSAs that are on SSU boundaries. TMA 140 includes a first padding means for adding padding to any incomplete sector in the additional data to be stored, so as to include a full sector of data. If the transfer length is such that the storage operation does not complete on an SSU boundary, the SSU is filled out with zero padding. This obviates the need for read-modify-write operations, because the RMW is performed for misaligned DSAs.

A lower boundary location of the payload data to be written is defined by the parameter SSU_DSU_OFFSET, and the payload data has a LENGTH. The last payload data location of the data to be stored is determined by the LENGTH and SSU_DSU_OFFSET. Because the RDE block 100 writes out a full SSU with each write, if the tail end of a storage request, as determined by the LENGTH plus SSU_DSU_OFFSET, intersects an SSU (i.e., ends before the upper SSU boundary), the remaining sectors of the SSU are written with zeros.

A procedure for ensuring that an entire SSU is written out with each write is below:
#define SSU ((NUMBER_OF_DISKS=1)?1: (NUMBER_OF_DISKS−1))

xfersize is calculated to be:
xfersize=SSU*N (where N is an integer—could vary depending on performance requirements)

The xfersize is a programmable parameter per session (where each session represents a respective data stream to be stored to disk or retrieved from disk).

In some embodiments, after sending a request, the next request address is provided by a module external to RDE 100, such as TMA 140. The next request address is calculated as follows:
new DSA=old DSA+xfersize

initial DSA is the start address of an object (This may be selected by software depending on the start of the object and is selected to be an SSU boundary).

This simple procedure will guarantee that the DSA is always aligned on an SSU boundary. (Selection of the xfersize ensure this).

When a transfer is performed, the starting DSA is calculated based on three parameters: the starting address, number of disks in use, and the transfer size. Based on these three factors, the starting DSA value is determined. The data are written to the first address, and then TMA 140 updates the data. Thus, the transfer size makes sure that SSUs are aligned after the starting DSA.

In some embodiments, padding within a sector is one by TMA 140, and padding for an SSU is one by a second padding means in RDE 100. For example, while sending data that does not fill out a sector. (e.g., the last sector has only 100 bytes of payload data), TMA 140 pads out the remainder of the full 512 bytes to make a full, complete sector. Then, RDE 100 pads out the rest of the SSU, if the last datum to be written does not fall on an SSU boundary.

In some other embodiments, a module other than TMA 140 may be responsible of inserting pad data to fill out an incomplete sector to be written to disk. In some other embodiments, a module other than RDE 100 may be responsible for inserting pad data to fill out an incomplete SSU to be written to disk.

A read modify write operation would be necessary if either the head or tail of a storage request could straddle SSU boundaries, and SSU zero padding were not performed. At the head, this would entail insertion of a specially marked retrieval request. At the tail, new retrieval and storage requests would be created. These extra tasks are avoided by writing full SSUs of data, aligned with a DSA boundary.

FIG. 2 is a block diagram of the wirte operation sequencer (WOS) 112 of FIG. 1.

Header Information identified by the valid Start of Header assertion is transferred to the Write Header Extraction Register (WHER) 202 from TMI 110 (shown in FIG. 1).

The TRANS module 204 calculates the LBA corresponding to the provided DSA. In addition to the LBA, the offsets of the requested payload data within the stripe and Parity Rotation are also obtained. The transfer length is distributed across the RAID cluster 132 and adjusted for any SSU offset (See “Length translations” further below.)

A dword count is maintained in the Write Operation State Register (WSOR) 206.

When the translations are completed the information is loaded into the Write Header Information Register (WHIR) 210 and Request Configuration Register (WCFR) 208.

FIG. 3 is a simplified state diagram for the Write Operation State Machine (WOSM) 212 of FIG. 2. The following terms are used in FIG. 3 and in the description of FIG. 3 below.

WIDLE is the Initial Idle or waiting for start of header resting state

WYTRAN (Write Translate) is the state during which the DSA translation is performed by the computational logic.

WHIRs (Write Header Information Requests)

WDSUs (Write Data Sector Units)

WPADs (Write Padded Sectors) is the state in which the padding is one to complete the SSU.

WPSU (Write Parity Sector Unit) is the state in which the parity data are generated.

In the write operation state machine (WOSM) 212 a RAID 4 operation is essentially performed, and other logic (not shown) handles the parity rotation. Storage request frames and Retrieval request frames are drawn into registers of a Write Input Buffer as requested by the WOSM 212. Header Information identified by a valid Start of Header assertion is transferred to the Write Header Extraction Register (WHER) 202. TMA 140 identifies to WHERE 202 the type read or write) of transfer (T), the RAC, the starting DSA, the length (in sectors) and the session (QID). A dword count is maintained in the Write Operation State Register (WOSR) 206. The TRANS module 204 calculates the LBA corresponding to the provided DSA. In addition to the LBA, the offsets within the stripe and Parity Rotation are obtained. The transfer length is distributed across the RAID cluster 144 and adjusted for any SSU offset. When the translations are completed, the information is loaded into the Header Information Register (WHIR) 210 and Request Configuration (WCFR) Register 208.

WIDLE (Idle)

In FIG. 3, state WIDLE is the Initial Idle state, or waiting-for-start-of-header resting state. This state can be entered from either the WHIRS state or the WPSU state. In the WIDLE state, the system is in the idle state until it receives a start-of-header signal from TMA 140. The system then goes to the translation state, and translation begins.

WTRAN (Write Translate)

In state WTRAN, the header information extracted from the TMA request header is copied, manipulated and translated to initialize the WHER 202, WOSR 206, WCFR 208 and WHIR 210 register sets, and an entry is written to the ROS issued request FIFO (IRF) 214. WHERE 202 stores the following parameters: T, RAC, starting DSA, LENGTH, and a session ID (QID). WOSR 206 stores the following parameters: Current DID, Current DSA, current LBA, current stripe, current parity rotation, current offsets, SSU count, DSU count, sector count and dword count. WCFR 208 stores the following parameters: starting offsets, RAC, LENGTH, cluster size (N), chunk size (K), and stripe DSUs K*(N−1). WHIR 210 stores the following parameters T, starting LBA, transfer count (XCNT), and QID. When translation is complete, the system goes from the WTRAN state to the WHIRs state.

WHIRs (Write Header Information Requests)

In state WHIRs, translated header information is written to the next block (MDC) for each drive identifier (DID) of the operative RAID Array Cluster Profile. After the translated header information for the last DID is completed, the system enters the WDSUs state.

WDSUs (Write data sector units, DSUs)

In state WDSUs, DSUs are presented in arrival sequence (RAID4_DID<N−1) to the MDC. Sectors destined for degraded drives (where RAID5_DID matches ldeg and degraded is TRUE) are blanked, in other words they are not loaded into the MDC. All of the data sector unit is written out to each DID of a stripe. When the sector unit for the DID N−1 is written, the system enters the WPSU state. When the DSU count is greater than LENGTH the system enters the WPADs state.

WPADs (Write Padded Sectors)

In some embodiments, the second padding means for filling the final SSU of data is included in the WOSM 212, and has a WPADs state for adding the fill. In state WPADs, Zero Padded sectors are presented sequentially (RAID4_DID<N−1) to the MDC 144. Sectors destined for degraded drives (where RAID5_DID matches ldeg an degraded is TRUE) are blanked, in other words they are not loaded into the MDC 144. The system remains in this state for each DID, until DID N−1, and then enters the WPSU state.

WPSU (Write PSU)

In state WPSU, the PSU (RAID4_DID=N−1) is presented to the MDC. Sectors destined for degraded drives (where RAID5_DID matches ldeg and degraded is TRUE) are blanked, in other words they are not loaded into the pending write FIFO (WPF). When SSUcount is less than the transfer count (XCNT), the system goes from state WPSU to state WDSUs. When SSUcount reaches XCNT, the system returns to the WIDLE state.

In one embodiment, from the perspective of this state machine 212, this state machine essentially performs RAID 4 processing all the time, and another separate circuit accomplishes the parity rotation (RAID 5 processing) by calculating where the data are and alternating the order at which the parity comes out. The drive ID used is the drive ID before parity rotation is applied. Essentially, the drive ID is the RAID 4 drive ID. Parity rotation accomplished separately.

Logical DSA translations

The LBA of an SSU can be obtained by dividing the DSA by one less than the number of drives in an array cluster. The remainder is the offset of the DSA within an SSU.

LBA = DSA/(N−1)
SSU_DSU_OFFSET = DSA mod (N−1)

The stripe number can be obtained by dividing the DSA by the product of the chunk size (K) and one less than the number of drives in an array cluster, with the remainder from the division being the OFFSET in DSUs from the beginning of the stripe. The STRIPE_SSU_OFFSET is the offset of the first DSU of an SSU within a stripe.

STRIPE = DSA/(K*(N−1))
STRIPE_DSU_OFFSET = DSA mod (K*(N−1))
STRIPE_SSU_OFFSET = STRIPE_DSU_OFFSET −

SSU_DSU_OFFSET

SSU_OF_STRIPE = STRIPE_SSU_OFFSET / (N−1)

Parity Rotation

The Parity Rotation (the number of disks to rotate through from the left-most) is the result of modulo division of the Stripe Number by the Number of drives. It ranges from zero to one less than the Number of drives in the RAID Cluster

PARROT = STRIPE mod N
keep PARROT in [0 .. N−1]
Drive Identifiers (DID)

Logical Drive Identifiers are used in operations that specify particular logical members of a RAID Array Cluster. DIDs range from zero to one less than the Number of drives in the RAID Cluster keep DID in [0 . . . N−1] Ignoring parity rotation, (as with RAID level 4), the logical disk drive number of the DSA within the SSU is the division's remainder.

RAID4_DID = DSA mod (N−1)
The Parity Sector's Logical Drive ID is one less than
the number of disk

drives in the array cluster less the parity rotation.

PAR_DID = (N - PARROT −1)
The RAID5 drive ID is just what it would have been for RAID4,
but adjusted

for Parity Rotation

if(RAID4_DID < PAR_DID)
then
RAID5_DID = RAID4_DID
else
RAID5_DID = RAID4_DID + 1
fi

In degraded mode, the ldeg is known

Given the Parity Rotation and the RAID5 drive ID, the Logical RAID4 drive ID can be obtained:

if (RAID5_DID == (N - PARROT −1)) //PAR_DID?
then
RAID4_DID = N−1
elsif(RAID5_DID < (N - PARROT −1))
RAID4_DID =RAID5_DID
else
RAID4_DID = RAID5_DID − 1
fi

The Physical Drive Identifier (PDID) specifies the actual physical drive.

The mapping of a RAID5_DID to the PDID is specified in the RAID Array Cluster's profile registers

Length translations

The Length obtained from the TMA 140 is expressed in DSUs. These DSUs are to be distributed over the RAID cluster 132. For retrieval, any non-zero offset is added to the length if required in order to retrieve entire SSUs. This per-drive length is the operative number of SSUs. The number of these SSUs is obtained by dividing the sum of the length and the offset by one less than the number of cluster drives, and rounding the quotient up. This Transfer count (XCNT) is provided to each of the MDC FIFOs corresponding to the RAID cluster drives and is expressed in sectors.

if ((LENGTH + SSU_DSU_OFFSET) mod (N−1) = 0)
then
XCNT = (LENGTH + SSU_DSU_OFFSET)/(N−1)
else
XCNT = ((LENGTH + SSU_DSU_OFFSET)/(N−1))+ 1
fi

Parity Block Processor (PBP) sub-block description

The PBP 114 performs Block Parity Generation on SSU sector data as directed by the WOS 112. As the first sector of a stripe unit data flows to the WIF 120, it is also copied to the Parity Sector Buffer (PSB). As subsequent sectors flow through to the WIF 120, the Parity Sector Buffer gets replaced with the exclusive-OR of its previous contents and the arriving data.

When N−1 sector units have been transferred, the PSB is transferred and cleared.

The LENGTH field is in units of data sectors and represents the data that are to be transferred between the RDE 100 and the TMA 140, which RDE 100 spreads over the entire array. The XCNT field is drive specific, and can include data and parity information that is not transferred between RDE 100 and the TMA 140. Thus, XCNT may differ from LENGTH transfer count. XCNT is the parameter that goes to the MDC 144. The amount of data written is the same for each disk, but the amount of data written is not the same as the length. The amount of data is the length divided by the number of drives minus one (because N−1 drives hold data, and one drive holds parity data).

In some embodiments, sixteen bits are allocated to the LENGTH, and the unit of length is in sectors, so that transfers may be up to 64K sectors (32 megabytes).

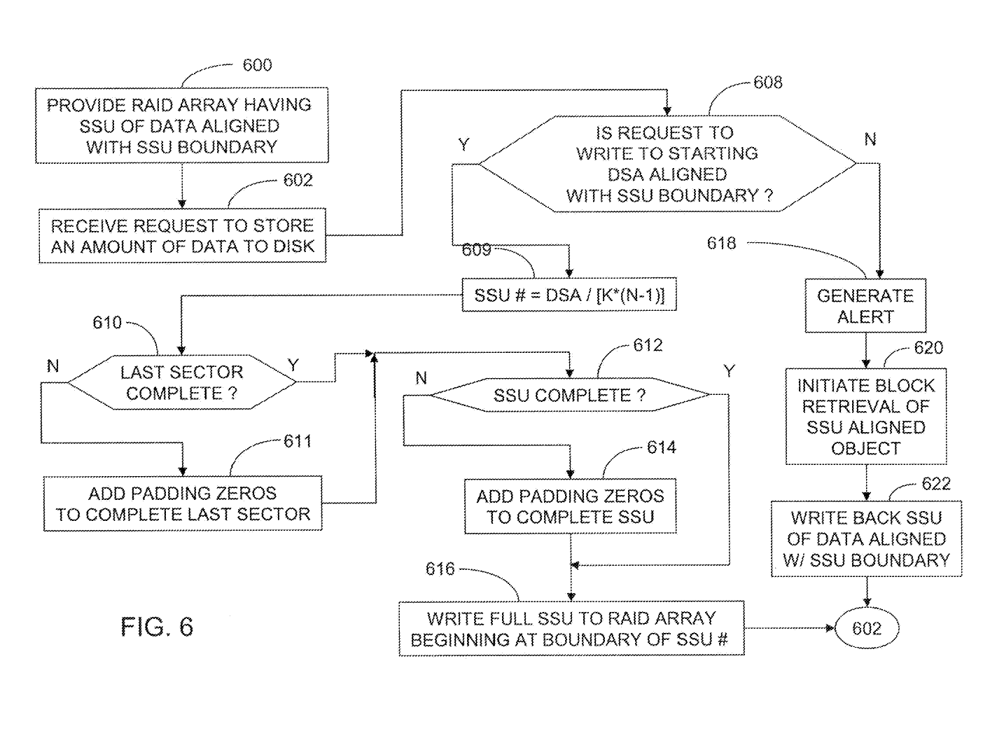

FIG. 6 is a flow chart showing an exemplary method.

At step 600, a RAID array 132 is provided, having an SSU of data written thereto, the SSU of data beginning at an SSU boundary and ending at an SSU boundary. For example, in some embodiments, at system initialization, an initial read-modify-write operation may be performed to cause an SSU of data (which may be dummy data) to be written with a starting DSA that is aligned with an SSU boundary.

At step 602, a request is received from a requestor to write additional data. For example, TMA 140 may receive a write request to store data from a streaming data session. In other embodiments, another module may receive the request. During normal operation, the requested starting DSA is aligned with the SSU boundary. However, the amount of additional data may be less than the size of an SSU. For example, in storing a large file to disk 132, having a file size that is not an even multiple of the SSU size, the final portion of the additional data to be stored to disk will have an amount that is less than the SSU size.

At step 608, a determination is made whether the request is a request to write data to a starting DSA that is aligned with an SSU boundary. If the requested starting DSA is aligned with an SSU boundary, step 609 is executed. If the requested starting DSA is not aligned with an SSU boundary, step 618 is executed.

At step 609, a stripe number (SSU #) is determined by dividing the requested DSA by a product of a chunk size (K) of the RAID array and a number that is one less than a number of disks in the RAID array.

At step 610, a determination is made whether the last sector of data to be stored is complete. For example, TMA 140 may make this determination. In other embodiments, another module may make the determination. If the sector is complete, step 612 is executed next. If the sector is incomplete, step 611 is executed next.

At step 611, any incomplete sector in the data to be stored is padded, so as to include a full sector of data. This step may be performed by TMA 140, or in other embodiments, by another module. In some embodiments, a means for padding the data is included in the TMA 140. Upon receipt of an amount of additional data to be stored to disk (e.g., a file), TMA determines a transfer size per request. This value indicates the number of data sectors transferred per request. This value is tuned to optimize the disk access performance. By dividing the amount of data (e.g., file size) by the sector size, an integer number of full sectors is determined, and a remainder would indicate an incomplete sector. TMA 140 subtracts the number of actual payload data in the final (incomplete) sector from the sector size (e.g., 512 bytes), to determine an amount of fill data that TMA 140 adds at the end of the final sector, when transmitting the final sector to RDE 100. This process is described in greater detail in application Ser. No. 60/724,464, which is incorporated by reference herein.

In other embodiments, the means for padding data may be included in RDE 100. In other embodiments, the means for padding data may include a first means in a first module (e.g., TMA 140) and a second means in a second module (e.g., RDE 100).

At step 612, a determination is made whether the amount of data identified in the request corresponds to an integer number of complete SSUs. If the amount of data is an integer number of complete SSUs, step 616 is executed next. If the amount of data includes an incomplete SSU, step 614 is added.

At step 614, the data to be stored are padded, so as to include a full SSU of data.

At step 616, the full SSU of data containing the requested DSA (and including the padding if any) is stored, beginning at a starting DSA that is aligned with the SSU boundary, without performing a read-modify-write operation.

At step 618, when a request is received to write to a starting DSA that is not aligned to an SSU boundary (e.g., if an attempt has made to write a partial object), in some embodiments, the system generates an alert, and may optionally enter a lock-up state. In other embodiments, steps 620 and 622 are automatically performed after the alert is generated at step 618.

At step 620, the hardware in RDE module 100 passes control to a software process (e.g., a process executed by application processor 142) that modifies the request to trigger a non-violating block retrieval operation of an SSU aligned object.

At step 622, AP 142 initiates a step of writing back the non-violating SSU of data, aligned along an SSU boundary (e.g., a full SSU of data or a partial SSU filled with padding zeros). Then, the RAID array 132 is in a similar state to that defined at step 600, and a subsequent write operation can be handled by TMA 140 and RDE 100 using the default process of steps 602-616.

In the example described above, a file-system suitable for handling large objects and specialized logic are used, avoiding RAID Array Read Modify Writes.

By using a file-system suitable for handling large objects, and beginning all RAID write operations with SSU aligned DSAs, and application of padding to the terminal SSU when appropriate, RMW operations are avoided. Once the initial aligned SSU is stored in the RAID array 132, with subsequent write operations (including the final portion of each file) sized to match the SSU size, each write operation has a starting DSA that is aligned on an SSU boundary, eliminating the RMW sequence, and improving storage performance.

To protect the Array Data, the logic detects requests to write using errant DSAs (i.e., DSAs that are not SSU aligned) and modifies them. This logic may be implemented in the hardware of TMA 140, or in software executed by AP 142. Logic for calculating the translation of DSAs ensures that the SSU_DSU_OFFSET is zero.

Thus, writes are allowed to stream to the RAID Array without having to wait for a Stripe Read otherwise required for Parity calculations by the PBP for Parity Sector Unit

In some embodiments, RDE 100 and TMA 140 are implemented in application specific integrated circuitry (ASIC). In some embodiments, the ASIC is designed manually. In some embodiments, a computer readable medium is encoded with pseudocode, wherein, when the pseudocode is processed by a processor, the processor generates GDSII data for fabricating an application specific integrated circuit that performs a method. An example of a suitable software program suitable for generating the GDSII data is “ASTRO” by Synopsys, Inc. of Mountain View, Calif.

In other embodiments, the invention may be embodied in a system having one or more programmable processors and/or coprocessors. The present invention, in sum or in part, can also be embodied in the form of program code embodied in tangible media, such as flash drives, DVDs, CD-ROMs, hard-drives, floppy diskettes, or any other machine-readable storage medium, wherein, when the program code is loaded into and executed by a machine, such as a computer, the machine becomes an apparatus of practicing the invention. The present invention can also be embodied in the form of program code, for example, whether stored in a storage medium, loaded into and/or executed by a machine, or transmitted over some transmission medium, such as over electrical wiring or cabling, through fiber-optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits.

Although the invention has been described in terms of exemplary embodiments, it is not limited thereto. Rather, the appended claims should be construed broadly, to include other variants and embodiments, which may be made by those skilled in the art without departing from the scope and range of equivalents of the invention.

1. A method comprising the steps of:
providing a redundant array of inexpensive disks (RAID) array having at least a stripe sector unit (SSU) of data written thereto;
receiving a request to perform a write operation to the RAID array beginning at a starting data storage address (DSA) that is not aligned with an SSU boundary; and
generating an alert in response to the request.

2. The method of claim 1, further comprising:
initiating a block retrieval of an SSU aligned object in response to the alert, The SSU aligned object including the data located at the DSA in the request; and
writing back an SSU of data to the RAID array, aligned with an SSU boundary, and including the DSA identified in the request.

3. The method of claim 2, wherein the written back data include a full SSU of valid data.

4. The method of claim 2, wherein the written back data include a partial SSU of valid data and sufficient padding to occupy an SSU in the RAID array.

5. A method comprising the steps of:
providing a redundant array of inexpensive disks (RAID) array having at least a stripe sector unit (SSU) of data written thereto, the SSU of data beginning at a first SSU boundary;
receiving a request from a requestor to write an amount of additional data to the RAID array;
padding the additional data if the amount of the additional data is less than an SSU of data, so as to include a full SSU of data in the padded additional data; and
storing the full SSU of data beginning at a starting data storage address (DSA) that is aligned with a second SSU boundary, without performing a read-modify-write operation.

6. The method of claim 5, further comprising restricting write operations to the RAID array so as to only include storage of one or more full SSUs.

7. The method of claim 5, wherein the padding step includes:
padding any incomplete sector in the additional data to be stored, so as to include a full sector of data.

8. The method of claim 5, wherein the storing step comprises:
determining a stripe number by dividing a requested DSA by a product of a chunk size (K) of the RAID array and a number that is one less than a number of disks in the RAID array; and
writing a full SSU of data containing a sector having the requested DSA to a stripe having the determined stripe number.

9. A system comprising:
a redundant array of inexpensive disks (RAID) array capable of having stripe sector units (SSU) of data written thereto; and
a RAID control module for receiving a request to perform a write operation to the RAID array beginning at a starting data storage address (DSA) that is not aligned with an SSU boundary and for generating an alert in response to the request.

10. The system of claim 9, further comprising:
a processor for initiating a block retrieval of an SSU aligned object in response to the alert, the SSU aligned object including the data located at the DSA in the request,
said processor being programmed to cause an SSU of data to be written back to the RAID array, aligned with an SSU boundary, and including the DSA identified in the request.

11. The system of claim 9, further comprising:
a first module for receiving a request from a requestor to write an amount of additional data to the RAID array; and
means for padding the additional data if the amount of the additional data is less than an SSU of data, so as to include a full SSU of data in the padded additional data,
wherein the RAID control module includes means for causing storage of the full SSU of data beginning at a starting data storage address (DSA) that is aligned with a second SSU boundary, without performing a read-modify-write operation.

12. A system comprising:
a redundant array of inexpensive disks (RAID) array having at least a stripe sector unit (SSU) of data written thereto, the SSU of data beginning at a first SSU boundary;
a first module that is capable of receiving a request from a requestor to write an amount of additional data to the RAID array;
means for padding the additional data if the amount of the additional data is less than an SSU of data, so as to include a full SSU of data in the padded additional data; and
a second module that is capable of causing the RAID array to store the full SSU of data beginning at a starting data storage address (DSA) that is aligned with a second SSU boundary, without performing a read-modify-write operation.

13. The system of claim 12, further wherein the second module restricts write operations to the RAID array so as to only include storage of one or more full SSUs.

14. The system of claim 12 wherein the padding means is included in at least one of the first module and the second module.

15. The system of claim 14 wherein the first module adds padding to any incomplete sector in the additional data to be stored, so as to include a full sector of data.

16. The system of claim 15, wherein the second module adds padding to the additional data to be stored, so as to include a full SSU of data.

17. The system of claim 15, wherein the second module includes means for determining a stripe number by dividing a requested DSA by a product of a chunk size (K) of the RAID array and a number that is one less than a number of disks in the RAID array; and
writing a full SSU of data containing a sector having the requested DSA to a stripe having the determined stripe number.

18. A computer readable medium encoded with pseudocode, wherein, when the pseudocode is processed by a processor, the processor generates GDSII data for fabricating an application specific integrated circuit that performs a method comprising the steps of:
providing a redundant array of inexpensive disks (RAID) array having at least a stripe sector unit (SSU) of data written thereto, the SSU of data beginning at a first SSU boundary;
receiving a request from a requestor to write an amount of additional data to the RAID array;
padding the additional data if the amount of the additional data is less than an SSU of data, so as to include a full SSU of data in the padded additional data; and
storing the full SSU of data beginning at a starting data storage address (DSA) that is aligned with a second SSU boundary, without performing a read-modify-write operation.

19. The computer readable medium of claim 18, wherein the method further comprises restricting write operations to the RAID array so as to only include storage of one or more full SSUs.

20. The computer readable medium of claim 19, wherein the padding step comprises:
padding any incomplete sector in the data to be stored, so as to include a full sector of data.

21. The compute readable medium of claim 18, wherein the storing step comprises:
determining a stripe number by dividing a requested DSA by a product of a chunk size (K) of the RAID array and a number that is one less than a number of disks in the RAID array; and
writing a full SSU of data containing a sector having the requested DSA to a stripe having the determined stripe number.
